(19) United States
(12) Patent Application Publication
(10) Pub. No.: US 2023/0067096 A1
(43) Pub. Date: Mar. 2, 2023

(54) INFORMATION PROCESSING DEVICE, COMPUTER PROGRAM PRODUCT, AND INFORMATION PROCESSING SYSTEM

(71) Applicant: KABUSHIKI KAISHA TOSHIBA, Tokyo (JP)

(72) Inventors: Tomonori MAEDA, Kawasaki Kanagawa (JP); Hiroyoshi HARUKI, Kawasaki Kanagawa (JP); Fukutomo NAKANISHI, Sumida Tokyo (JP); Jun KANAI, Inagi Tokyo (JP)

(73) Assignee: KABUSHIKI KAISHA TOSHIBA, Tokyo (JP)

(21) Appl. No.: 17/677,429

(22) Filed: Feb. 22, 2022

(30) Foreign Application Priority Data
Aug. 31, 2021 (JP) 2021-141079

(51) Int. Cl. G06N 5/04; G06N 5/02

(52) U.S. Cl. CPC G06N 5/04; G06N 5/022

(57) ABSTRACT

According to an embodiment, an information processing device includes an obtaining unit and a communication generating unit. The obtaining unit obtains first communication data of a first environment, first configuration information, and second configuration information. First identification information of each first device of a plurality of first devices in the first environment is associated with function identification information of a function of the first device in the first configuration information. Second identification information of each second device of a plurality of second devices in a second environment is associated with function identification information of a function of the second device in the second configuration information. The communication generating unit generates communication prediction data of the second environment by substituting first identification information in the first communication data with second identification information corresponding to function identification information of a function of a first device identified by the first identification information.

### CROSS-REFERENCE TO RELATED APPLICATIONS

This application is based upon and claims the benefit of priority from Japanese Patent Application No. 2021-141079, filed on Aug. 31, 2021; the entire contents of which are incorporated herein by reference.

### FIELD

Embodiments described herein relate generally to an information processing device, a computer program product, and an information processing system.

### BACKGROUND

The communication data communicated among a plurality of devices present in a particular environment is used in the learning of a learning model of that environment. For example, in a particular environment, communication data having high communication frequencies and communication data having low communication frequencies is collected and is used in the learning of a learning model of that environment. However, since the collection of communication data having low communication frequencies, such as once a month, requires time; the increase in the learning time sometimes becomes an issue.

As far as the technologies for shortening the learning time are concerned, a technology has been disclosed that reduces the number of sets of data required in the learning (for example, refer to He Zhang, et al. “Deep Adversarial Learning in Intrusion Detection: A Data Augmentation Enhanced Framework” (arXiv 2019)). Moreover, a model has been disclosed in which a predictive value predicted from the number of past relay communications is used instead of using communication data; and, when the actual observation count exceeds the predictive value, some abnormality related to the communication data is determined to have occurred (for example, refer to Japanese Patent Application Laid-open No. 2006-238043).

However, in He Zhang, et al. “Deep Adversarial Learning in Intrusion Detection: A Data Augmentation Enhanced Framework” (arXiv 2019), the collection of communication data having low communication frequencies requires time, it becomes a difficult task to shorten the learning time. Moreover, in Japanese Patent Application Laid-open No. 2006-238043, instead of using the communication data, the number of instances of relay communication is used as the input to the model; and it is not possible to determine any abnormality in the communication data having low communication frequencies. That is, in the conventional technology, it is a difficult task to hold down a decline in the learning accuracy as well as to shorten the learning time.

### BRIEF DESCRIPTION OF THE DRAWINGS

FIG. 1 is a schematic diagram illustrating an example of an information processing system;

FIG. 2 is a schematic diagram illustrating an example of a first environment and a second environment;

FIG. 3A is a schematic diagram illustrating an exemplary data configuration of first communication data;

FIG. 3B is a schematic diagram illustrating an exemplary data configuration of first configuration information;

FIG. 3C is a schematic diagram illustrating an exemplary data configuration of second configuration information;

FIG. 3D is a schematic diagram illustrating an exemplary data configuration of identification correspondence information;

FIG. 3E is a schematic diagram illustrating an exemplary data configuration of communication prediction data;

FIG. 4 is a schematic diagram illustrating an example of the first environment and the second environment;

FIG. 5A is a schematic diagram illustrating an exemplary data configuration of the first communication data;

FIG. 5B is a schematic diagram illustrating an exemplary data configuration of the first configuration information;

FIG. 5C is a schematic diagram illustrating an exemplary data configuration of the second configuration information;

FIG. 5D is a schematic diagram illustrating an exemplary data configuration of the identification correspondence information;

FIG. 5E is a schematic diagram illustrating an exemplary data configuration of the communication prediction data;

FIG. 5F is a schematic diagram illustrating an exemplary data configuration of the communication prediction data;

FIG. 6 is a schematic diagram illustrating an example of the first environment and the second environment;

FIG. 7A is a schematic diagram illustrating an exemplary data configuration of the first communication data;

FIG. 7B is a schematic diagram illustrating an exemplary data configuration of the first configuration information;

FIG. 7C is a schematic diagram illustrating an exemplary data configuration of the second configuration information;

FIG. 7D is a schematic diagram illustrating an exemplary data configuration of the identification correspondence information;

FIG. 7E is a schematic diagram illustrating another exemplary data configuration of the communication prediction data;

FIG. 8A is a schematic diagram illustrating an exemplary data configuration of the first communication data;

FIG. 8B is a schematic diagram illustrating an exemplary data configuration of the first configuration information;

FIG. 8C is a schematic diagram illustrating an exemplary data configuration of the second configuration information;

FIG. 8D is a schematic diagram illustrating an exemplary data configuration of the identification correspondence information;

FIG. 8E is a schematic diagram illustrating an exemplary data configuration of the communication prediction data;

FIG. 9 is a flowchart for explaining an exemplary flow of the information processing;

FIG. 10 is a schematic diagram illustrating an example of an information processing system;

FIG. 11A is a schematic diagram illustrating an exemplary data configuration of communication prototype information;

FIG. 11B is a schematic diagram illustrating an exemplary data configuration of the communication prediction data;

FIG. 12 is a flowchart for explaining an exemplary flow of the information processing; and

FIG. 13 is an exemplary hardware configuration diagram.

### DETAILED DESCRIPTION

According to an embodiment, an information processing device includes an obtaining unit and a communication generating unit. The obtaining unit obtains first communication data of a first environment, first configuration information, and second configuration information. The first environment includes a plurality of first devices. First identification information of each first device of the plurality of first devices included in the first environment is associated with function identification information of a function of the first device in the first configuration information. Second identification information of each second device of a plurality of second devices included in a second environment is associated with function identification information of a function of the second device in the second configuration information. The communication generating unit generates communication prediction data of the second environment by substituting first identification information included in the first communication data with second identification information corresponding to function identification information of a function of a first device identified by the first identification information.

Exemplary embodiments of an information processing device, a computer program product, and an information processing system are described below in detail with reference to the accompanying embodiments.

### First Embodiment

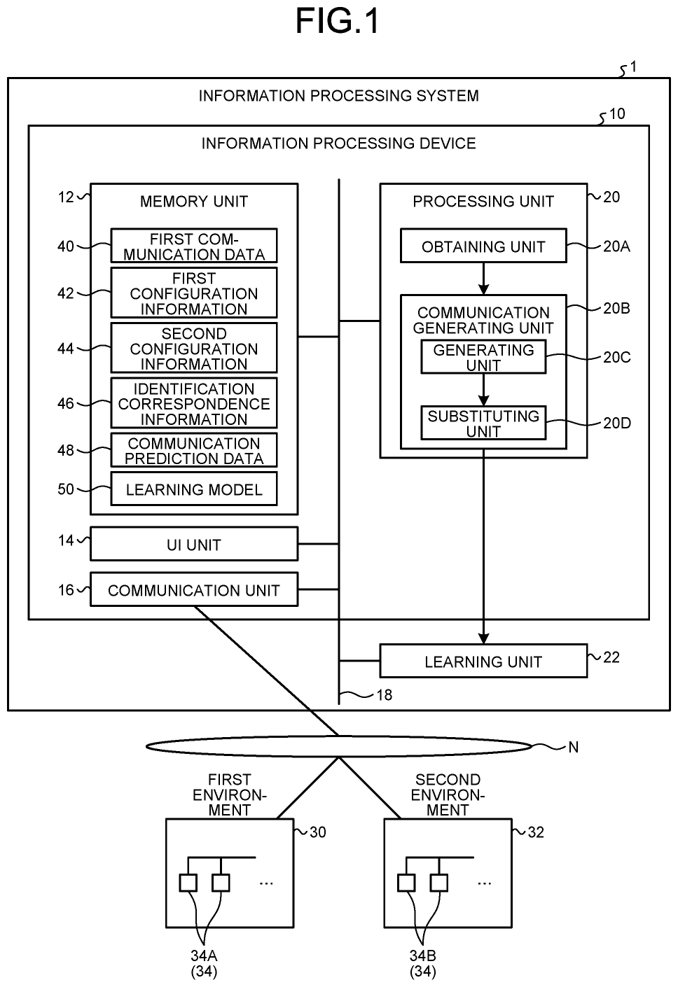

FIG. 1 is a schematic diagram illustrating an example of an information processing system 1 according to a first embodiment.

The information processing system 1 is communicably connected, via a network N, to devices 34 that are present in a first environment 30 and in a second environment 32. Herein, the information processing system 1 can be connected to the devices 34, which are present in the first environment 30 and the second environment 32, in such a way that data can be sent and received via a memory medium. Alternatively, the information processing system 1 can be connected to server devices, which are present in the first environment 30 and the second environment 32, in such a way that data can be sent to and received from the server devices.

The first environment 30 represents an example of a test environment that includes a plurality of first devices 34A. Herein, the first devices 34A represent an example of the devices 34. The first devices 34A are equipped at least with the communication function. Moreover, the first devices 34A present in the first environment 30 communicate data among themselves.

The second environment 32 represents an example of a real environment that includes a plurality of second devices 34B. Herein, the first devices 34A represent an example of the devices 34. The second devices 34B are equipped at least with the communication function. Moreover, the second devices 34B present in the second environment 32 communicate data among themselves.

In the first environment 30 and the second environment 32, there are one or more devices 34 having the same function. In other words, among the first devices 34A present in the first environment 30 and the second devices 34B present in the second environment 32, at least some of the functions are common.

The functions of the devices 34 imply their classification or their role in the respective environments, namely, the first environment 30 and the second environment 32. Herein, the classification implies the labels of a plurality of groups formed by grouping the devices 34 according to predetermined classification conditions. Moreover, the role implies the role assumed by the devices 34 in the respective environments.

Examples of the functions of the devices 34 include, but are not limited to, the programmable logic controller (PLC), the human machine interface (HMI), and the intrusion detection system (IDS).

Meanwhile, the functions of the devices 34 can also be in a more segmentalized form. For example, any function can be further segmentalized according to the differences in the communication protocol. More particularly, for example, the PLC for temperature regulation and the PLC for water amount regulation either can be treated as the same function or can be treated as different functions.

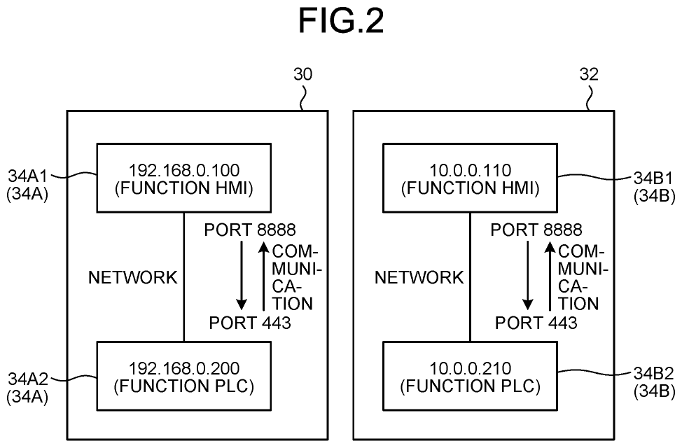

FIG. 2 is a schematic diagram illustrating an example of the first environment 30 and the second environment 32.

The first environment 30 includes, for example, two first devices 34A, namely, first devices 34A1 and 34A2. The first devices 34A1 and 34A2 communicate with each other via a network within the first environment 30. Meanwhile, to each of the first devices 34A, first identification information is assigned in advance.

The first identification information enables unique identification of the first devices 34A. As long as the first identification information enables unique identification of the first devices 34A, it serves the purpose.

As the first identification information, for example, information such as the addresses is used that enables identification of the source and the destination during the communication performed among the first devices 34A within the first environment 30. The addresses during communication that are used as the first identification information can be, for example, the IP addresses (IP stands for Internet Protocol) or the MAC addresses (MAC stands for Media Access Control) of the first devices 34A.

Meanwhile, as long as the first identification information enables unique identification of the first devices 34A, it serves the purpose. Hence, for example, information that is changeable according to the environment of the first devices 34A can be used as the first identification information. In that case, examples of the first identification information include the port number, the VLAN ID (which stands for Virtual Local Area Network Identity Document), the PLC station ID, and the channel number of serial communication.

The port number represents the number used in the TCP/IP communication (TCP/IP stands for Transmission Control Protocol/Internet Protocol). In the following explanation, the port number is sometimes simply referred to as the port. The VLAN ID represents the information used in identifying each instance of communication when the communication of a plurality of segments is performed using the same cable. The PLC station ID represents the information used in identifying the communication partner for PLC. The channel number of serial communication represents the information used in identifying the communication performed using the same serial cable.

In the first embodiment, the explanation is given about an example in which the IP addresses of the first devices 34A are used as the first identification information.

The second environment 32 includes, for example, two second devices 34B, namely, second devices 34B1 and 34B2. The second devices 34B1 and 34B2 communicate with each other via a network within the second environment 32. Meanwhile, to each of the second devices 34B, second identification information is assigned in advance.

The second identification information enables unique identification of the second devices 34B. In an identical manner to the first identification information, examples of the second identification information include the IP addresses of the second devices 34B, the MAC addresses of the second devices 34B, the port numbers, the VLAN IDs, the PLC station IDs, and the channel numbers of serial communication. In the first embodiment, the explanation is given about an example in which the IP addresses of the second devices 34B are used as the second identification information.

Returning to the explanation with reference to FIG. 1, the information processing system 1 includes an information processing device 10 and a learning unit 22. The information processing device 10 and the learning unit 22 are communicably connected to each other via a bus 18.

The information processing device 10 uses first communication data 40 of the first environment 30 and generates communication prediction data 48 of the second environment 32. Regarding the first communication data 40 and the communication prediction data 48, the detailed explanation is given later.

The information processing device 10 includes a processing unit 20, a memory unit 12, a user interface (UI) unit 14, and a communication unit 16. The memory unit 12, the UI unit 14, the communication unit 16, the processing unit 20, and the learning unit 22 are communicably connected to each other via the bus 18.

The memory unit 12 is used to store a variety of data. For example, the memory unit 12 can be a semiconductor memory device such as a random access memory (RAM) or a flash memory; or can be a hard disk; or can be an optical disk. Alternatively, the memory unit 12 can be a memory device installed on the outside of the information processing device 10. Meanwhile, the configuration can be such that at least either the memory unit 12, or the UI unit 14, or one or more functional units of the processing unit 20, or the learning unit 22 can be installed in an external information processing device that is communicably connected to the information processing device 10 via the network N.

The UI unit 14 has a display function for displaying a variety of information, and has a receiving function for receiving operation instructions from the user. The communication unit 16 communicates, via the network N, with the devices 34 or server devices present in the first environment 30 and the second environment 32.

The processing unit 20 performs information processing in the information processing device 10. The processing unit 20 includes an obtaining unit 20A and a communication generating unit 20B. The communication generating unit 20B includes a generating unit 20C and a substituting unit 20D.

The obtaining unit 20A, the communication generating unit 20B, the generating unit 20C, and the substituting unit 20D are implemented using, for example, one or more processors. For example, the abovementioned constituent elements can be implemented by making a processor such as a central processing unit (CPU) execute computer programs, that is, can be implemented using software. Alternatively, the abovementioned constituent elements can be implemented using a processor such as a dedicated integrated circuit (IC), that is, can be implemented using hardware. Still alternatively, the abovementioned constituent elements can be implemented using a combination of software and hardware. In the case of using a plurality of processors, each processor can implement one of the constituent elements or can implement two or more constituent elements.

The obtaining unit 20A obtains the first communication data 40, first configuration information 42, and second configuration information 44.

The first communication data 40 represents the communication data of the first environment 30. More specifically, the first communication data 40 represents the group of sets of data communicated among the first devices 34A within the first environment 30.

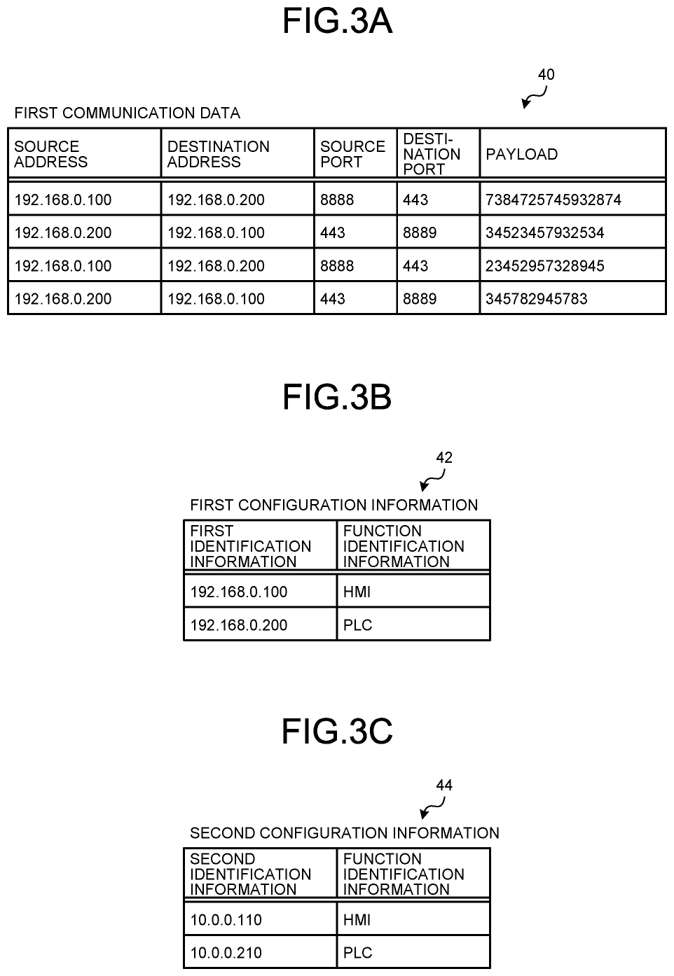

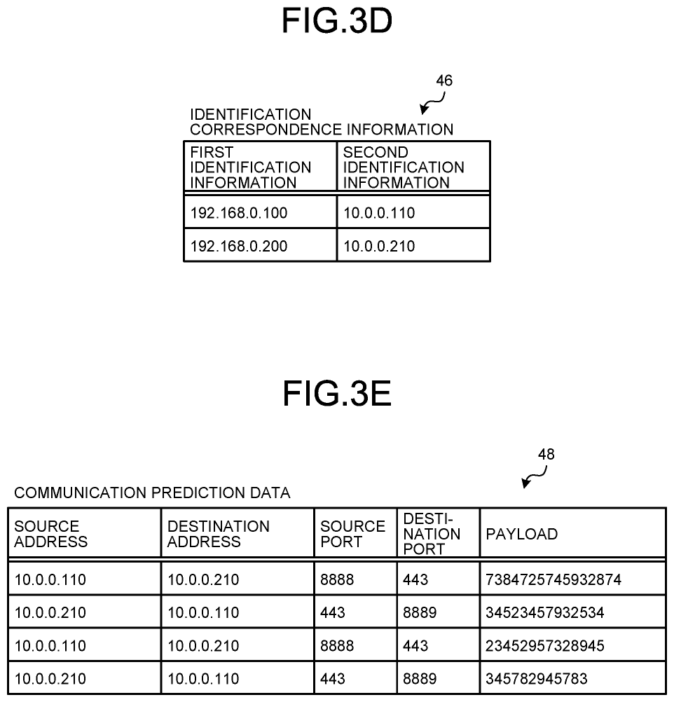

FIG. 3A is a schematic diagram illustrating an exemplary data configuration of the first communication data 40. In FIG. 3A is illustrated an example of the first communication data 40 when the first environment 30 is as illustrated in FIG. 2.

The first communication data 40 is made of a group of one or more packets that include: communication destination information representing the first identification information of the first devices 34A present in the first environment 30; and data body. A packet represents an example of the smallest unit of communication performed among the first devices 34A.

A packet includes, for example, a source address, a destination address, a source port, a destination port, and a payload. The source address represents the IP address of the first device 34A that sent the data. The destination address represents the IP address of the first device 34A to which the data is to be delivered. The source port represents the port of the first device 34A that sent the data. The destination port represents the port of the first device 34A to which the data is to be delivered. Thus, the source address and the source port as well as the destination address and the destination port represent examples of the communication destination information representing the first identification information of the first devices 34A. As mentioned earlier, in the first embodiment, that explanation is given about an example in which the IP addresses, that is, the source address and the destination address are used as the first identification information.

FIG. 3B is a schematic diagram illustrating an exemplary data configuration of the first configuration information 42. In FIG. 3B is illustrated an example of the first configuration information 42 when the first environment 30 is as illustrated in FIG. 2.

The first configuration information 42 indicates the configuration of the first devices 34A present in the first environment 30. More specifically, in the first configuration information 42, the first identification information of each first device 34A is associated with function identification information of the function of that first device 34A identified by the first identification information.

The function identification information enables unique identification of the function. In the function identification information, for example, the name of the function is used. In the first embodiment, the explanation is given for an example in which the name of the function such as “HMI” or “PLC” is used.

FIG. 3C is a schematic diagram illustrating an exemplary data configuration of the second configuration information 44. In FIG. 3C is illustrated an example of the second configuration information 44 when the second environment is as illustrated in FIG. 2.

The second configuration information 44 indicates the configuration of the second devices 34B present in the second environment 32. More specifically, in the second configuration information 44, the second identification information of each second device 34B is associated with function identification information of the function of that second device 34B identified by the second identification information.

Returning to the explanation with reference to FIG. 1, the obtaining unit 20A obtains the first communication data 40 and the first configuration information 42 from the first environment 30 via the communication unit 16. Moreover, the obtaining unit 20A obtains the second configuration information 44 from the second environment 32 via the communication unit 16. Alternatively, the first communication data 40, the first configuration information 42, and the second configuration information 44 can be stored in advance in the memory unit 12. In that case, the obtaining unit 20A can obtain the first communication data 40, the first configuration information 42, and the second configuration information 44 from the memory unit 12.

The communication generating unit 20B generates the communication prediction data 48 of the second environment by substituting the first identification information included in the first communication data 40 with the second identification information that corresponds to the function identification information of the function of such first devices 34A which are identified by the first identification information.

In the first embodiment, the communication generating unit 20B includes the generating unit 20C and the substituting unit 20D.

Based on the first configuration information 42 and the second configuration information 44, the generating unit 20C generates identification correspondence information 46 in which the first identification information and the second identification information corresponding to the same function identification information are associated.

FIG. 3D is a schematic diagram illustrating an exemplary data configuration of the identification correspondence information 46. In the identification correspondence information 46, the first identification information and the second identification information are associated. In FIG. 3D is illustrated an example of the identification correspondence information 46 that is generated using the first configuration information 42 illustrated in FIG. 3B and using the second configuration information 44 illustrated in FIG. 3C.

As illustrated in FIG. 3B, in the first configuration information 42, first identification information “192.168.0.100” corresponding to the function identification information “HMI” is registered. Moreover, as illustrated in FIG. 3C, in the second configuration information 44, second identification information “10.0.0.110” corresponding to the function identification information “HMI” is registered. In that case, the generating unit 20C registers, in the identification correspondence information 46, the first identification information “192.168.0.100” and the second identification information “10.0.0.110” corresponding to the same function identification information “HMI” in association with each other (see FIG. 3D).

Moreover, as illustrated in FIG. 3B, in the first configuration information 42, first identification information “192.168.0.200” corresponding to the function identification information “PLC” is registered. Moreover, as illustrated in FIG. 3C, in the second configuration information 44, second identification information “10.0.0.210” corresponding to the function identification information “PLC” is registered. In that case, the generating unit 20C registers, in the identification correspondence information 46, the first identification information “192.168.0.200” and the second identification information “10.0.0.210” corresponding to the same function identification information “PLC” in association with each other (see FIG. 3D).

Returning to the explanation with reference to FIG. 1, the substituting unit 20D generates the communication prediction data 48 by substituting the first identification information included in the first communication data 40 with the corresponding second identification information included in the identification correspondence information 46.

In the communication prediction data 48, the communication data of the second environment 32 is predicted. In other words, the communication prediction data 48 is the communication data of the second environment 32 as predicted using the first communication data 40 of the first environment 30. More specifically, the communication prediction data 48 represents, as predicted using the first communication data 40, a group of packets that would be communicated among the second devices 34B within the second environment 32.

FIG. 3E is a schematic diagram illustrating an exemplary data configuration of the communication prediction data 48. In FIG. 3E is illustrated an example of the communication prediction data 48 generated using the first communication data 40 illustrated in FIG. 3A, the first configuration information 42 illustrated in FIG. 3B, the second configuration information 44 illustrated in FIG. 3C, and the identification correspondence information 46 illustrated in FIG. 3D.

The substituting unit 20D substitutes the source addresses and the destination addresses, which represent the first identification information in the first communication data 40 illustrated in FIG. 3A, with the corresponding second identification information included in the identification correspondence information 46 illustrated in FIG. 3D. As a result of performing the substitution operation, the substituting unit 20D generates the communication prediction data 48 illustrated in FIG. 3E.

In this way, the communication generating unit 20B generates the communication prediction data 48 by substituting the first identification information included in the first communication data 40 with the second identification information that corresponds to the function identification information of the function of such first devices 34A which are identified by the first identification information. That is, as a result of substituting the first identification information included in the first communication data 40 of the first environment 30, which represents the test environment, with the second identification information of the second devices 34B having the same functions; the communication generating unit 20B generates the communication prediction data 48 of the second environment 32. Thus, the communication generating unit 20B can make use of the first communication data 40 of the first environment 30, which is the test environment, in the second environment 32.

Moreover, in the first environment 30 representing the test environment, testing is performed by implementing a variety of communication. In the communication performed among the first devices 34A present in the first environment 30 that is the test environment, a variety of data (packets) such as the communication data having high communication frequencies and the communication data having low communication frequencies is included. Hence, by making use of the first communication data 40 of the first environment 30, which is the test environment, in the second environment 32; the communication generating unit 20B can easily generate the communication prediction data 48 that contains packets having various communication frequencies.

Meanwhile, in FIG. 2 is illustrated the exemplary configuration in which the first environment 30 as well as the second environment 32 includes two devices 34. However, as long as the first environment 30 as well as the second environment 32 includes a plurality of devices 34, it serves the purpose. Thus, at least either the first environment 30 or the second environment 32 can include three or more devices 34.

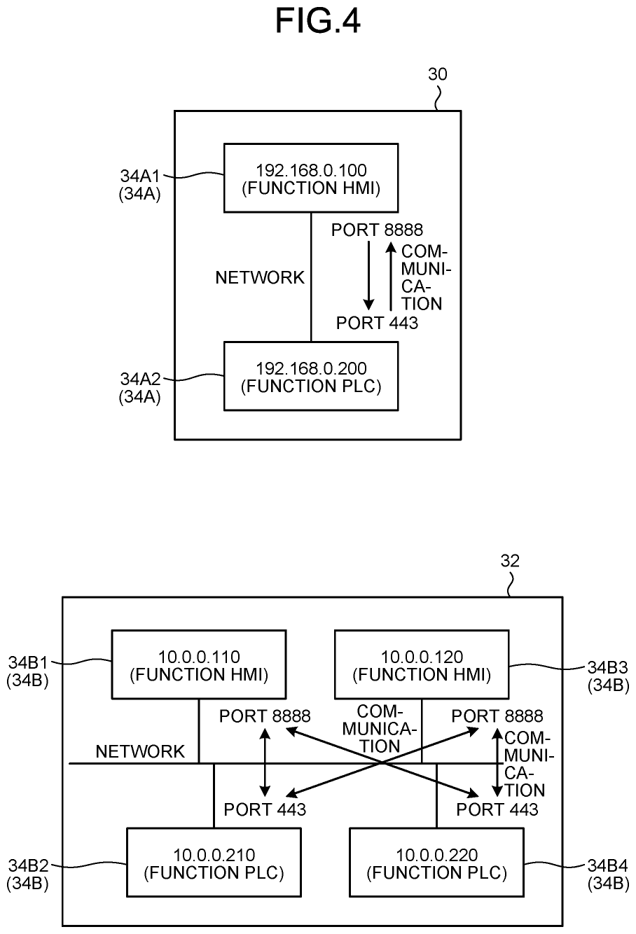

FIG. 4 is a schematic diagram illustrating another example of the first environment 30 and the second environment 32.

For example, the first environment 30 includes two first devices 34A, namely, the first devices 34A1 and 34A2. Moreover, for example, the second environment 32 includes four devices 34, namely, second devices 34B1, 34B2, 34B3, and 34B4. The second devices 34B1, 34B2, 34B3, and 34B4 communicate with each other via a network within the second environment 32.

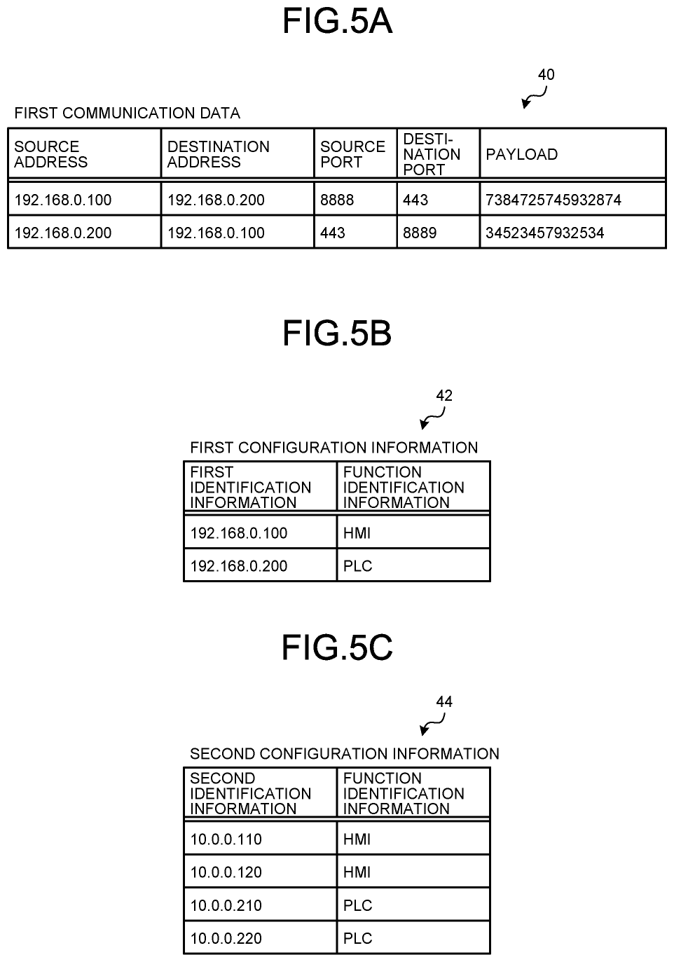

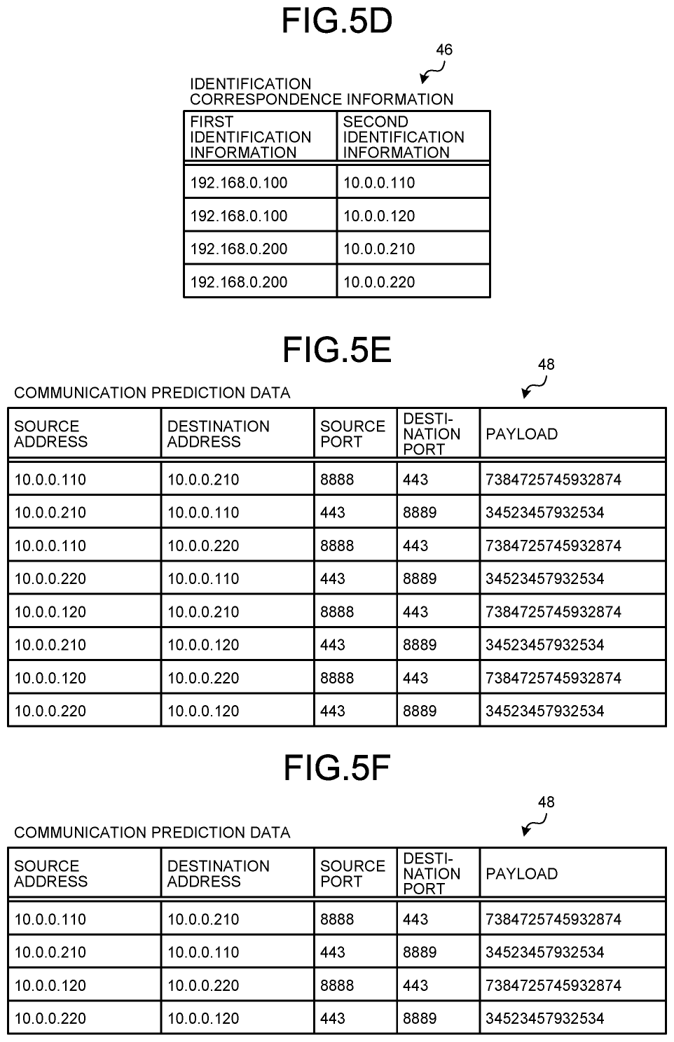

In that case, the first communication data 40, the first configuration information 42, and the second configuration information 44 obtained by the obtaining unit 20A is as illustrated in FIGS. 5A, 5B, and 5C, respectively.

FIG. 5A is a schematic diagram illustrating an exemplary data configuration of the first communication data 40. In FIG. 5A is illustrated an example of the first communication data 40 when the first environment 30 is as illustrated in FIG. 4.

FIG. 5B is a schematic diagram illustrating an exemplary data configuration of the first configuration information 42. In FIG. 5B is illustrated an example of the first configuration information 42 when the first environment 30 is as illustrated in FIG. 4.

FIG. 5C is a schematic diagram illustrating an exemplary data configuration of the second configuration information 44. In FIG. 5C is illustrated an example of the second configuration information 44 when the second environment 32 is as illustrated in FIG. 4.

In that case, based on the first configuration information 42 illustrated in FIG. 5B and the second configuration information 44 illustrated in FIG. 5C, the generating unit 20C generates the identification correspondence information 46 in which the first identification information and the second identification information corresponding to the same function identification information are associated.

FIG. 5D is a schematic diagram illustrating an exemplary data configuration of the identification correspondence information 46. In FIG. 5D is illustrated an example of the identification correspondence information 46 that is generated using the first configuration information 42 illustrated in FIG. 5B and using the second configuration information 44 illustrated in FIG. 5C.

As illustrated in FIG. 5B, in the first configuration information 42, the first identification information “192.168.0.100” corresponding to the function identification information “HMI” is registered. Moreover, as illustrated in FIG. 5C, in the second configuration information 44, second identification information “10.0.0.110” and “10.0.0.120” corresponding to the function identification information “HMI” is registered. In that case, as illustrated in FIG. 5D, the generating unit 20C registers, in the identification correspondence information 46, the first identification information “192.168.0.100” and the second identification information “10.0.0.110” corresponding to the same function identification information “HMI” in association with each other. Moreover, the generating unit 20C registers, in the identification correspondence information 46, the first identification information “192.168.0.100” and the second identification information “10.0.0.120” corresponding to the same function identification information “HMI” (see FIG. 5D) in association with each other.

As illustrated in FIG. 5B, in the first configuration information 42, the first identification information “192.168.0.200” corresponding to the function identification information “PLC” is registered. Moreover, as illustrated in FIG. 5C, in the second configuration information 44, second identification information “10.0.0.210” and “10.0.0.220” corresponding to the function identification information “PLC” is registered. In that case, as illustrated in FIG. 5D, the generating unit 20C registers, in the identification correspondence information 46, the first identification information “192.168.0.200” and the second identification information “10.0.0.210” corresponding to the same function identification information “PLC” in association with each other. Moreover, the generating unit 20C registers, in the identification correspondence information 46, the first identification information “192.168.0.200” and the second identification information “10.0.0.220” corresponding to the same function identification information “PLC” in association with each other.

Then, the substituting unit 20D generates the communication prediction data 48 by substituting the first identification information included in the first communication data 40 illustrated in FIG. 5A with the corresponding second identification information included in the identification correspondence information 46 illustrated in FIG. 5D.

FIG. 5E is a schematic diagram illustrating another exemplary data configuration of the communication prediction data 48. In FIG. 5E is illustrated an example of the communication prediction data 48 generated using the first communication data 40 illustrated in FIG. 5A, the first configuration information 42 illustrated in FIG. 5B, the second configuration information 44 illustrated in FIG. 5C, and the identification correspondence information 46 illustrated in FIG. 5D.

The substituting unit 20D substitutes the source addresses and the destination addresses, which represent the first identification information in the first communication data 40 illustrated in FIG. 5A, with the corresponding second identification information included in the identification correspondence information 46 illustrated in FIG. 5D. As a result of performing the substitution operation, the substituting unit 20D generates the communication prediction data 48 illustrated in FIG. 5E.

As illustrated in FIG. 5D, in the identification correspondence information 46, sometimes a single set of first identification information is registered to have a plurality of sets of second identification information associated thereto. More particularly, in the identification correspondence information 46 illustrated in FIG. 5D, the first identification information “192.168.0.100” is registered to have the sets of second identification information “10.0.0.110” and “10.0.0.120” associated thereto. Moreover, in the identification correspondence information 46, the first identification information “192.168.0.200” is registered to have the sets of second identification information “10.0.0.210” and “10.0.0.220” associated thereto.

In that case, as illustrated in FIG. 5E, for every pair including one set of first identification information and each of a plurality of different sets of second identification information corresponding to the concerned first identification information, the substituting unit 20D can generate the communication prediction data 48 by substituting the first identification information of the first communication data 40 with the second identification information.

Alternatively, as illustrated in FIG. 5F, for every pair including one set of first identification information and only one of a plurality of different sets of second identification information corresponding to the concerned first identification information, the substituting unit 20D can generate the communication prediction data 48 by substituting the first identification information of the first communication data 40 with the second identification information. FIG. 5F is a schematic diagram illustrating another exemplary data configuration of the communication prediction data 48.

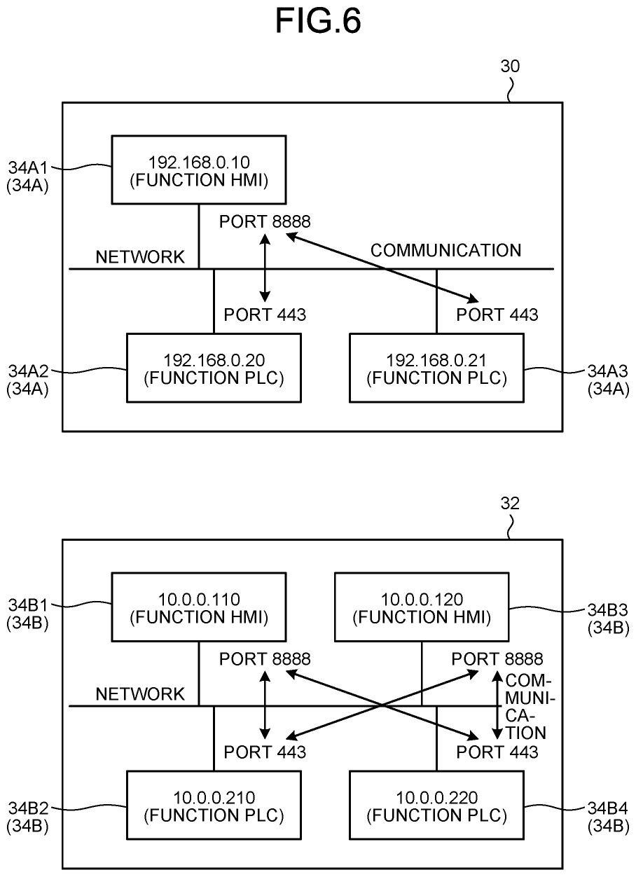

FIG. 6 is a schematic diagram illustrating another example of the first environment 30 and the second environment 32.

For example, the first environment 30 includes three first devices 34A, namely, first devices 34A1, 34A2, and 34A3. The first devices 34A1, 34A2, and 34A3 communicate with each other via a network within the first environment 30. Moreover, for example, the second environment 32 includes four devices 34, namely, the second devices 34B1, 34B2, 34B3, and 34B4. The second devices 34B1, 34B2, 34B3, and 34B4 communicate with each other via a network within the second environment 32.

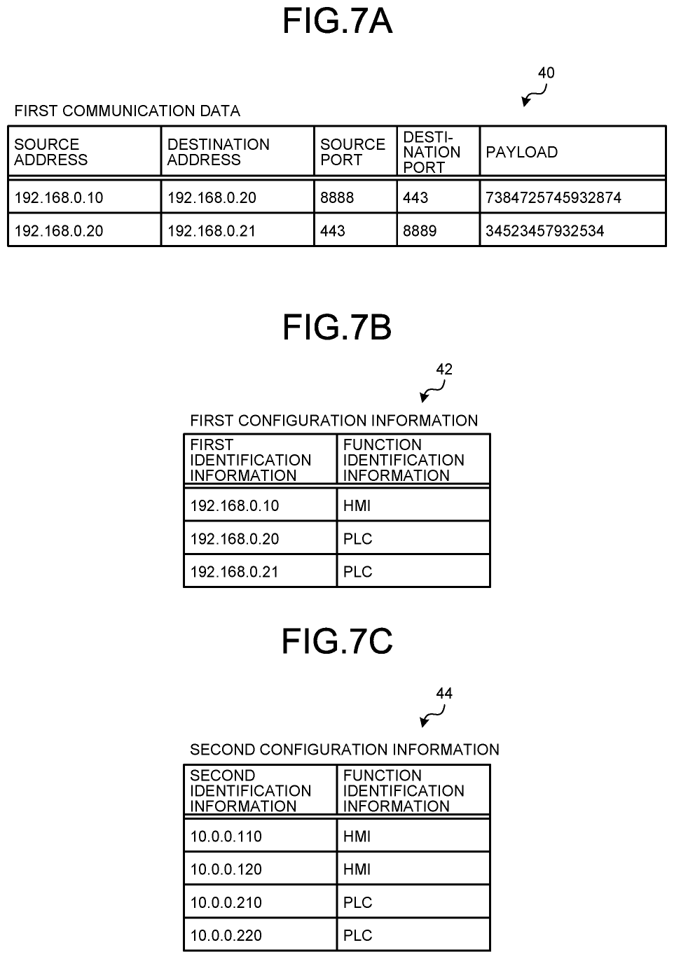

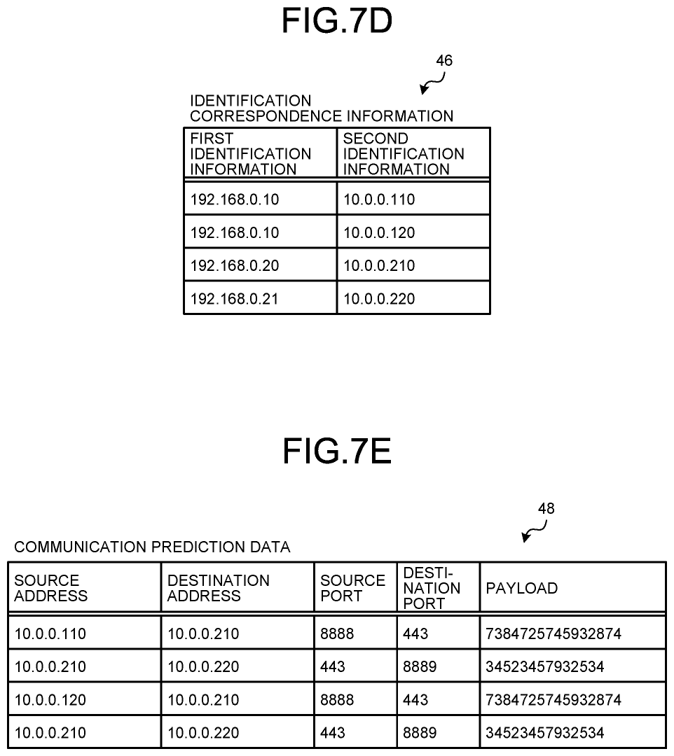

In that case, the first communication data 40, the first configuration information 42, and the second configuration information 44 obtained by the obtaining unit 20A is as illustrated in FIGS. 7A, 7B, and 7C, respectively.

FIG. 7A is a schematic diagram illustrating an exemplary data configuration of the first communication data 40. In FIG. 7A is illustrated an example of the first communication data 40 when the first environment 30 is as illustrated in FIG. 6.

FIG. 7B is a schematic diagram illustrating an exemplary data configuration of the first configuration information 42. In FIG. 7B is illustrated an example of the first configuration information 42 when the first environment 30 is as illustrated in FIG. 6.

FIG. 7C is a schematic diagram illustrating an exemplary data configuration of the second configuration information 44. In FIG. 7C is illustrated an example of the second configuration information 44 when the second environment 32 is as illustrated in FIG. 6.

In that case, based on the first configuration information 42 illustrated in FIG. 7B and the second configuration information 44 illustrated in FIG. 7C, the generating unit 20C generates the identification correspondence information 46 in which the first identification information and the second identification information corresponding to the same function identification information are associated.

FIG. 7D is a schematic diagram illustrating an exemplary data configuration of the identification correspondence information 46. In FIG. 7D is illustrated an example of the identification correspondence information 46 that is generated using the first configuration information 42 illustrated in FIG. 7B and using the second configuration information 44 illustrated in FIG. 7C.

As illustrated in FIG. 7B, in the first configuration information 42, first identification information “192.168.0.10” corresponding to the function identification information “HMI” is registered. Moreover, as illustrated in FIG. 7C, in the second configuration information 44, the second identification information “10.0.0.110” and “10.0.0.120” corresponding to the function identification information “HMI” is registered. In that case, as illustrated in FIG. 7D, the generating unit 20C registers, in the identification correspondence information 46, the first identification information “192.168.0.10” and the second identification information “10.0.0.110” corresponding to the same function identification information “HMI” in association with each other. Moreover, the generating unit 20C registers, in the identification correspondence information 46, the first identification information “192.168.0.10” and the second identification information “10.0.0.120” corresponding to the same function identification information “HMI” in association with each other.

As illustrated in FIG. 7B, in the first configuration information 42, first identification information “192.168.0.20” and “192.168.0.21” corresponding to the function identification information “PLC” is registered. As illustrated in FIG. 7C, in the second configuration information 44, the second identification information “10.0.0.210” and “10.0.0.220” corresponding to the function identification information “PLC” is registered. In that case, as illustrated in FIG. 7D, the generating unit 20C registers, in the identification correspondence information 46, the first identification information “192.168.0.20” and the second identification information “10.0.0.210” corresponding to the same function identification information “PLC” in association with each other. Moreover, the generating unit 20C registers, in the identification correspondence information 46, the first identification information “192.168.0.21” and the second identification information “10.0.0.220” corresponding to the same function identification information “PLC” in association with each other.

Then, the substituting unit 20D generates the communication prediction data 48 by substituting the first identification information included in the first communication data 40, which is illustrated in FIG. 7A, with the corresponding second identification information included in the identification correspondence information 46 illustrated in FIG. 7D.

FIG. 7E is a schematic diagram illustrating another exemplary data configuration of the communication prediction data 48. In FIG. 7E is illustrated an example of the communication prediction data 48 generated using the first communication data 40 illustrated in FIG. 7A, the first configuration information 42 illustrated in FIG. 7B, the second configuration information 44 illustrated in FIG. 7C, and the identification correspondence information 46 illustrated in FIG. 7D.

The substituting unit 20D substitutes the source addresses and the destination addresses, which represent the first identification information in the first communication data 40 illustrated in FIG. 7A, with the corresponding second identification information included in the identification correspondence information 46 illustrated in FIG. 7D. As a result of performing the substitution operation, the substituting unit 20D generates the communication prediction data 48 illustrated in FIG. 7E.

Meanwhile, sometimes the first communication data 40 contains such first identification information which does not get substituted with any second identification information. In that case, the communication generating unit 20B can delete the communication prediction data 48 generated from that first communication data 40. A specific example is explained below.

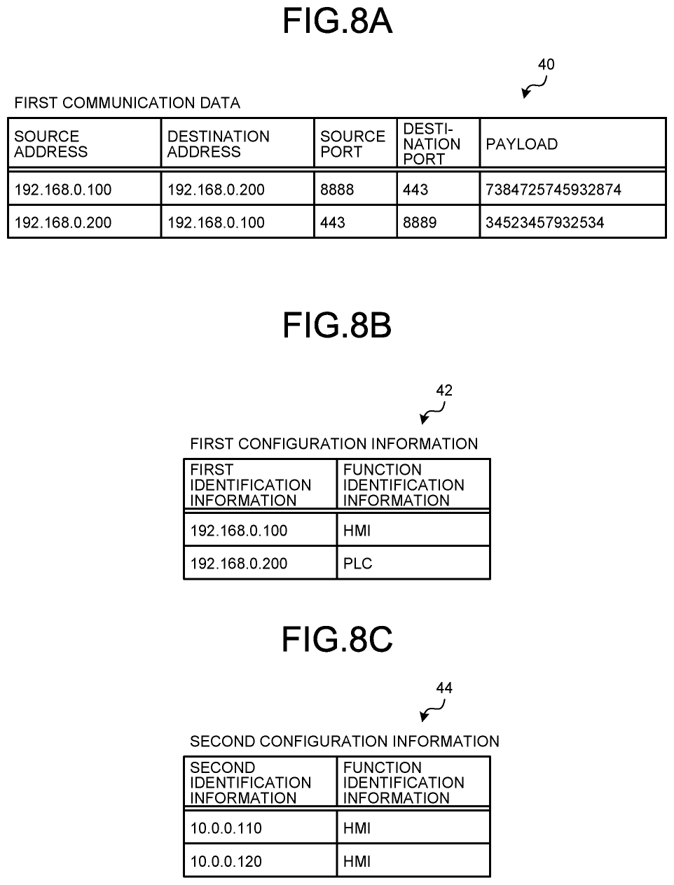

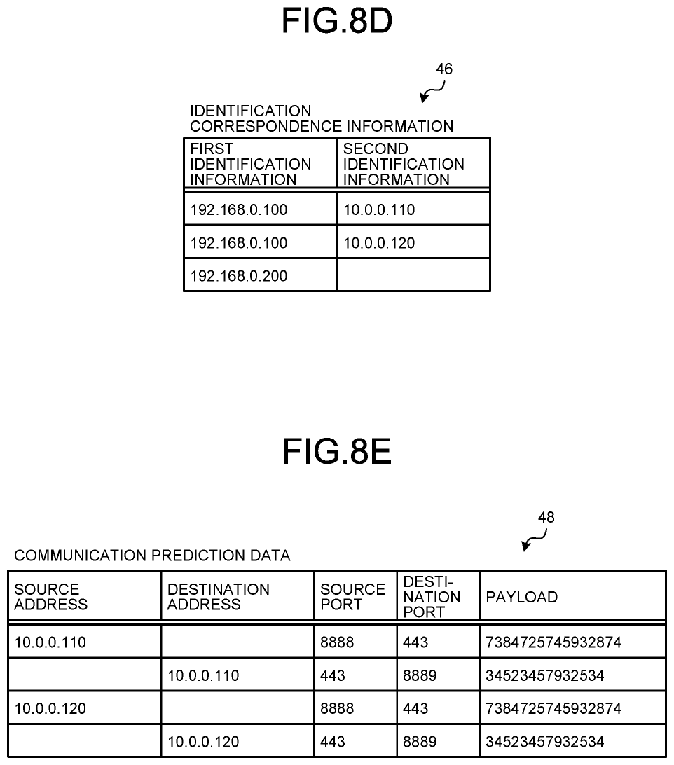

FIG. 8A is a schematic diagram illustrating an exemplary data configuration of the first communication data 40. FIG. 8B is a schematic diagram illustrating an exemplary data configuration of the first configuration information 42. FIG. 8C is a schematic diagram illustrating an exemplary data configuration of the second configuration information 44.

For example, assume that the obtaining unit 20A obtains the first communication data 40 illustrated in FIG. 8A, obtains the first configuration information 42 illustrated in FIG. 8B, and obtains the second configuration information 44 illustrated in FIG. 8C.

In that case, the generating unit 20C generates the identification correspondence information 46 illustrated in FIG. 8D. FIG. 8D is a schematic diagram illustrating an exemplary data configuration of the identification correspondence information 46. In the second configuration information 44 illustrated in FIG. 8C, the function identification information “HMI” is not included. Hence, the generating unit 20C becomes unable to register, in the identification correspondence information 46, the second identification information in association with the first identification information “192.168.0.200” that corresponds to the function identification information “PLC” included in the first configuration information 42. For that reason, in the column of the second identification information, a blank field is left that corresponds to the first identification information “192.168.0.200” included in the identification correspondence information 46.

In that case, the communication prediction data 48 that is generated by the substituting unit 20D by substituting the first identification information, which is included in the first communication data 40 illustrated in FIG. 8A, with the corresponding second identification information, which is present in the identification correspondence information 46 illustrated in FIG. 8D, becomes as illustrated in FIG. 8E. FIG. 8E is a schematic diagram illustrating an exemplary data configuration of the communication prediction data 48. Herein, the first identification information “192.168.0.200” included in the first communication data 40 does not get substituted with any second identification information, thereby leaving blank spaces. As a result, the communication prediction data 48 represents communication data in which at least some part of the first identification information, which is included in the first communication data 40 illustrated in FIG. 8A, is not substituted with any second identification information.

In that case, the communication generating unit 20B deletes the communication prediction data 48 illustrated in FIG. 8E. That is, when the first communication data 40 contains such first identification information which does not get substituted with any second identification information, the communication generating unit 20B deletes the communication prediction data 48 generated from the first communication data 40. Hence, when the first communication data 40 contains such first identification information which does not get substituted with any second identification information, the communication generating unit 20B can destroy the communication prediction data 48 that is generated.

The following explanation is given again with reference to FIG. 1.

Based on the communication prediction data 48 generated by the communication generating unit 20B, the learning unit 22 performs learning of a learning model 50.

The learning model 50 is a machine learning model that outputs whether or not the communication data of the second environment 32 is normal. More specifically, the learning model 50 is a normality machine learning model that treats the communication data of the second environment 32 as input, and outputs whether or not the communication data is normal. Alternatively, the learning model 50 can be an abnormality machine learning model that treats the communication data of the second environment 32 as input, and outputs whether or not the communication data is not normal.

The fact that the communication data is normal implies that, for example, the communication data does not represent an attack on the second environment 32 or there is no abnormality in the second devices 34B. The fact that the communication data is not normal implies that, for example, the communication data represents an attack on the second environment 32 or there is anomaly in the second devices 34B.

The learning unit 22 performs learning of the learning model 50 using the communication prediction data 48 and the communication data of the second environment 32 as the learning data. As far as the learning of the learning model 50 by the learning unit 22 is concerned, it is possible to implement a known learning method such as a recurrent neural network (RNN).

Since the communication prediction data 48 is used as the learning data, the learning unit 22 can make use of the first communication data 40 of the first environment 30, which is the test environment, in the learning data.

As explained above, in the first environment 30 representing the test environment, testing is performed by implementing a variety of communication. In the communication performed among the first devices 34A present in the first environment 30 that is the test environment, a variety of data such as the communication data having high communication frequencies and the communication data having low communication frequencies is included. For that reason, by making use of the first communication data 40 of the first environment 30, which represents the test environment, in the second environment 32; the learning unit 22 becomes able to use the communication prediction data 48, which contains packets having various communication frequencies, as the learning data. That enables the learning unit 22 to perform learning of the learning model 50 while holding down a decline in the learning accuracy.

Moreover, since the learning unit 22 uses, as the learning data, the communication prediction data 48 that is generated by the communication generating unit 20B; the communication prediction data 48 generated in a short period of time can be used as the learning data. That enables the learning unit 22 to shorten the learning time.

Meanwhile, the configuration can be such that the information processing device 10 includes the learning unit 22. In that case, the processing unit 20 can be configured to include the learning unit 22. Alternatively, the learning unit 22 can be installed in an external information processing device that is communicably connected to the information processing device 10 via the network N.

Given below is the explanation of an exemplary flow of the information processing performed in the information processing system 1 according to the first embodiment.

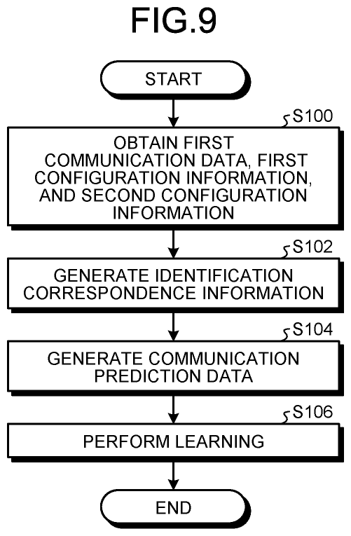

FIG. 9 is a flowchart for explaining an exemplary flow of the information processing performed in the information processing system 1 according to the first embodiment.

The obtaining unit 20A obtains the first communication data 40, the first configuration information 42, and the second configuration information 44 (Step S100).

Based on the first configuration information 42 and the second configuration information 44, the generating unit 20C generates the identification correspondence information 46 in which the first identification information and the second identification information corresponding to the same function identification information are associated (Step S102).

The substituting unit 20D generates the communication prediction data 48 by substituting the first identification information included in the first communication data 40, which is obtained at Step S100, with the corresponding second identification information included in the identification correspondence information 46 generated at Step S102 (Step S104).

The learning unit 22 performs learning of the learning model 50 based on the communication prediction data 48 generated at Step S104 (Step S106). It marks the end of the present routine.

As explained above, the information processing device 10 according to the first embodiment includes the obtaining unit 20A and the communication generating unit 20B. The obtaining unit 20A obtains the first communication data 40, the first configuration information 42, and the second configuration information 44. The communication generating unit 20B generates the communication prediction data 48 of the second environment 32 by substituting the first identification information included in the first communication data 40 with the second identification information corresponding to function identification information of the function of such first devices 34A which are identified by the first identification information.

In this way, the communication generating unit 20B generates, as the communication data of the second environment 32, the communication prediction data 48 by substituting the first identification information included in the first communication data 40 with the second identification information corresponding to function identification information of the function of such first devices 34A which are identified by the first identification information. That is, the communication generating unit 20B generates the communication prediction data 48 of the second environment 32 by substituting the first identification information included in the first communication data 40 of the first environment 30, which is the test environment, with the second identification information of the second devices 34B having the same functions. Hence, the communication generating unit 20B can make use of the first communication data 40 of the first environment 30, which is the test environment, in the second environment 32.

Meanwhile, in the first environment 30 representing the test environment, testing is performed by implementing a variety of communication. In the communication performed among the first devices 34A present in the first environment 30 that is the test environment, a variety of data such as the communication data having high communication frequencies and the communication data having low communication frequencies is included. For that reason, by making use of the first communication data 40 of the first environment 30, which represents the test environment, in the second environment 32; the communication generating unit 20B can easily generate the communication prediction data 48 that contains packets having various communication frequencies.

Hence, in the information processing device 10 according to the first embodiment, the first communication data 40 that is of the first environment 30 and that contains various of packets can be used as the communication prediction data 48 of the second environment 32, which is different than the first environment 30. That is, in the information processing device 10 according to the first embodiment, by making use of the first communication data 40 of the first environment 30, the communication prediction data 48 containing packets having various communication frequencies can be generated as the learning data to be used for performing learning of the learning model 50 that is used in the second environment 32. Hence, in the information processing device 10 according to the first embodiment, it becomes possible to generate the communication prediction data 48 that enables holding down a decline in the learning accuracy.

In the information processing device 10 according to the first embodiment, the communication prediction data 48 of the second environment 32 is generated by making use of the first communication data 40 of the first environment 30. Hence, in the information processing device 10 according to the first embodiment, as compared to the case of collecting the communication data among the second devices 34B present in the second environment 32, the data to be used for performing learning of the learning model 50 can be prepared in a shorter period of time.

Thus, in the information processing device 10 according to the first embodiment, the communication prediction data 48 is used as the learning data of the learning model 50 to be used in the second environment. That enables holding down a decline in the learning accuracy of the learning model 50 and shortening the learning time.

Hence, in the information processing device 10 according to the first embodiment, it becomes possible to hold down a decline in the learning accuracy of the learning model 50 and to shorten the learning time.

For example, assume that the first environment 30 represents the test environment for testing the real operations, and that the second environment 32 represents the real environment. Moreover, assume that the first environment 30 representing the test environment includes, as the first devices 34A, a plurality of devices 34 having the same functions as at least some of a plurality of second devices 34B present in the second environment 32 representing the real environment.

In that case, in the first environment 30 representing the test environment for testing the operations, a diverse variety of packets are sent and received for the operation testing. The communication generating unit 20B generates the communication prediction data 48 by making use of the first communication data 40 containing those packets of the first environment 30. Hence, before the commencement of the operations, the communication generating unit 20B can generate, with ease and in a short period of time, the communication prediction data 48 that is equivalent to the communication data obtained only after operating the second environment 32 for a long period of time.

Meanwhile, assume that the first environment 30 represents the test environment for training purposes, and that the second environment 32 represents the real environment. Moreover, assume that the first environment 30 representing the test environment includes, as the first devices 34A, a plurality of devices 34 having the same functions as at least some of a plurality of second devices 34B present in the second environment 32 representing the real environment.

In that case, in the first environment 30 representing the test environment for training purposes, it becomes possible to try out a diverse variety of packets for training purposes. The communication generating unit 20B generates the communication prediction data 48 by making use of the first communication data 40 containing those packets of the first environment 30. Hence, the communication generating unit 20B can generate, in a short period of time and without having to use the second environment 32, the communication prediction data 48 as the predicted communication data of the second environment 32.

Meanwhile, since the first communication data 40 of the second environment 32 is generated by making use of the first communication data 40 of the first environment 30, the communication generating unit 20B can easily generate the communication prediction data 48 without actually running the second environment 32 or without building the same environment as the second environment 32.

In the information processing device 10 according to the first embodiment, the communication generating unit 20B includes the generating unit 20C and the substituting unit 20D. The generating unit 20C generates, based on the first configuration information 42 and the second configuration information 44, the identification correspondence information 46 in which the first identification information and the second identification information corresponding to the same function identification information are associated. The substituting unit 20D generates the communication prediction data 48 by substituting the first identification information included in the first communication data 40 with the corresponding second identification information included in the identification correspondence information 46.

Since the communication prediction data 48 is generated using the identification correspondence information 46 generated by the generating unit 20C, the substituting unit 20D can generate the communication prediction data 48 in a shorter period of time. Hence, in the information processing device 10 according to the first embodiment, in addition to achieving the effects explained above, it also becomes possible to shorten the learning time.

In the information processing system 1 according to the first embodiment, the learning unit 22 performs learning of the learning model 50 based on the communication prediction data 48.

Assume that the learning model 50 is a machine learning model that outputs whether or not the communication data input thereto represents an attack on the second environment 32. In that case, the learning model 50 is used in attack detection. As the learning model 50 used in attack detection, a learning model for learning the normality and a learning model for learning the abnormality can be cited.

In order to learn the abnormality, it becomes necessary to perform an abnormality generation operation such as causing an abnormality in the second environment 32 or carrying out a cyber-attack on the second environment 32. However, performing an abnormality generation operation in the second environment 32 in the running state is a difficult task from the perspective of maintaining security and reliability. On the other hand, performing an abnormality generation operation in the first environment 30 is easier because of it being the test environment. Hence, when the communication prediction data 48, which is generated using the first communication data 40 obtained as a result of performing an abnormality generation operation in the first environment 30, is used in the learning; the learning unit 22 becomes able to perform learning of the learning model 50 of the abnormality with a high degree of accuracy and in a short period of time. Moreover, the learning unit 22 becomes able to perform learning of the learning model 50, which enables detection of an abnormality such as an attack with a high degree of accuracy, without performing an abnormality generation operation in the second environment 32 in the running state.

### Second Embodiment

In the first embodiment described above, the explanation is given about the case in which the communication prediction data 48 is generated using the identification correspondence information 46. In a second embodiment, the explanation is given about the case in which the communication prediction data 48 is generated using communication prototype information 47 instead of using the identification correspondence information 46.

In the second embodiment, the constituent elements identical to the first embodiment are referred to by the same reference numerals, and their detailed explanation is not given again.

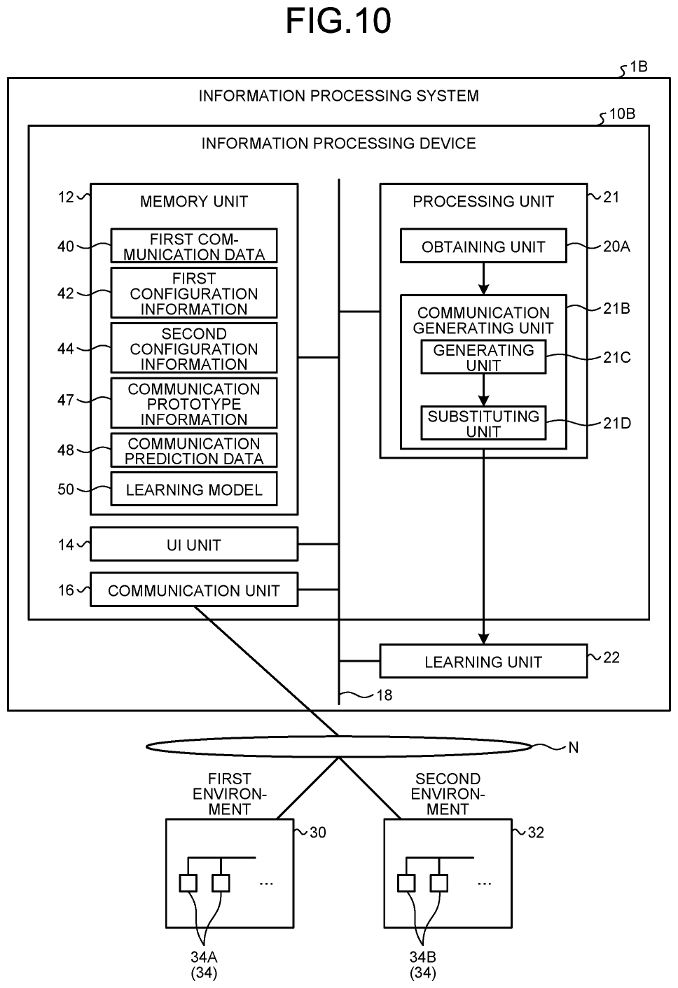

FIG. 10 is a schematic diagram illustrating an example of an information processing system 1B according to the second embodiment.

The information processing system 1B is identical to the information processing system 1 according to the first embodiment, except for the fact that an information processing device 10B is included in place of the information processing device 10. Moreover, the information processing device 10B is identical to the information processing device 10 according to the first embodiment, except for the fact that a processing unit 21 is included in place of the processing unit 20 and that the communication prototype information 47 is used in place of the identification correspondence information 46.

The processing unit 21 performs information processing in the information processing device 10B. The processing unit 21 includes the obtaining unit 20A and a communication generating unit 21B. Moreover, the communication generating unit 21B includes a generating unit 21C and a substituting unit 21D.

The obtaining unit 20A, the communication generating unit 21B, the generating unit 21C, and the substituting unit 21D are implemented using, for example, one or more processors. For example, the abovementioned constituent elements can be implemented by making a processor such as a CPU execute computer programs, that is, can be implemented using software. Alternatively, the abovementioned constituent elements can be implemented using a processor such as a dedicated IC, that is, can be implemented using hardware. Still alternatively, the abovementioned constituent elements can be implemented using a combination of software and hardware. In the case of using a plurality of processors, each processor can implement one of the constituent elements or can implement two or more constituent elements.

The obtaining unit 20A is identical to the obtaining unit 20A according to the first embodiment.

The communication generating unit 21B generates, in an identical manner to the communication generating unit 20B according to the first embodiment, the communication prediction data 48 of the second environment 32 by substituting the first identification information included in the first communication data 40 with the second identification information corresponding to the function identification information of the function of such first devices 34A which are identified by the first identification information.

In the second embodiment, the communication generating unit 21B includes the generating unit 21C and the substituting unit 21D.

The generating unit 21C generates, based on the first configuration information 42, the communication prototype information 47 by substituting the first identification information included in the first communication data 40 with the corresponding function identification information. For example, assume that the obtaining unit 20A obtains the first communication data 40 illustrated in FIG. 3A, obtains the first configuration information 42 illustrated in FIG. 3B, and obtains the second configuration information 44 illustrated in FIG. 3C. In that case, the generating unit 21C generates the communication prototype information 47 using the first communication data 40 and the first configuration information 42.

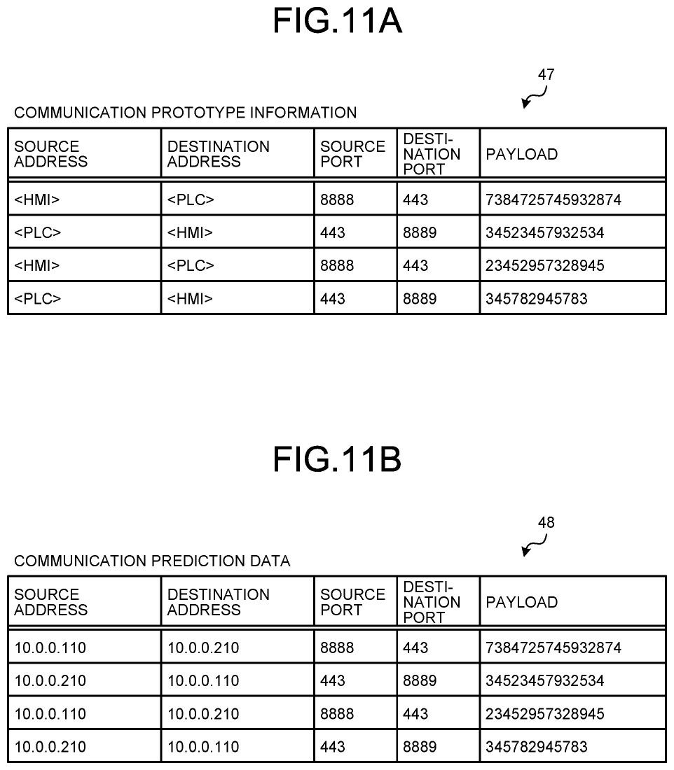

FIG. 11A is a schematic diagram illustrating an exemplary data configuration of the communication prototype information 47. In FIG. 11A is illustrated an example of the communication prototype information 47 generated using the first communication data 40 illustrated in FIG. 3A and using the first configuration information 42 illustrated in FIG. 3B.

In the communication prototype information 47, the first identification information included in the first communication data 40 is substituted with the second identification information corresponding to the same function identification information based on the first configuration information 42 and the second configuration information 44.

As explained earlier with reference to FIG. 3A, in the first communication data 40, the sources addresses and the destination addresses are registered that represent examples of the first identification information. The generating unit 21C identifies, from the first configuration information 42 illustrated in FIG. 3B, the function identification information corresponding to each set of the first identification information, which indicates the source addresses and the destination addresses included in the first communication data 40. Then, the generating unit 21C substitutes the first identification information included in the first communication data 40 with the corresponding function identification information that is identified, and generates the communication prototype information 47.

Thus, the first identification information “192.168.0.100” included in the first communication data 40 illustrated in FIG. 3A is substituted with the function identification information “HMI” as illustrated in FIG. 11A. In an identical manner, the first identification information “192.168.0.200” included in the first communication data 40 illustrated in FIG. 3A is substituted with the function identification information “PLC” as illustrated in FIG. 11A.

The substituting unit 21D generates the communication prediction data 48 by substituting the function identification information included in the communication prototype information 47 with the second identification information that corresponds to the concerned function identification information and that is included in the second configuration information 44.

FIG. 11B is a schematic diagram illustrating an exemplary data configuration of the communication prediction data 48. In FIG. 11B is illustrated an example of the communication prediction data 48 generated using the first communication data 40 illustrated in FIG. 3A, the first configuration information 42 illustrated in FIG. 3B, the second configuration information 44 illustrated in FIG. 3C, and the communication prediction data 48 illustrated in FIG. 11B.

The substituting unit 21D substitutes each set of function identification information, which is included in the communication prototype information 47 illustrated in FIG. 11A, with the corresponding second identification information included in the second configuration information 44 illustrated in FIG. 3C. Hence, the function identification information “HMI” included in the communication prototype information 47 gets substituted with the second identification information “10.0.0.110”, and the function identification information “PLC” included in the communication prototype information 47 gets substituted with the second identification information “10.0.0.210”. As a result of performing the substitution operation, the substituting unit 21D generates the communication prediction data 48.

Meanwhile, in an identical manner to the first embodiment described above, if the first communication data 40 contains such first identification information which does not get substituted with any second identification information, then the communication generating unit 21B can delete the communication prediction data 48 generated from the first communication data 40.

Given below is the explanation of an exemplary flow of the information processing performed in the information processing system 1B according to the second embodiment.

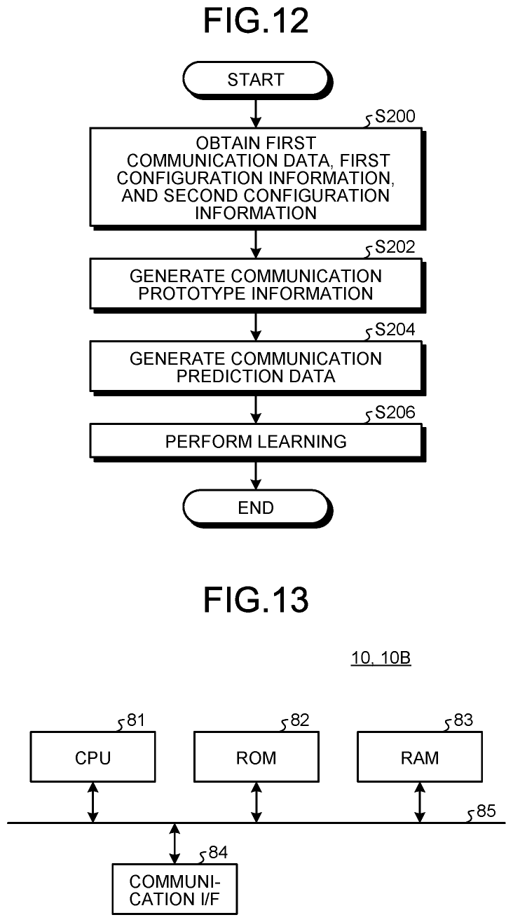

FIG. 12 is a flowchart for explaining an exemplary flow of the information processing performed in the information processing system 1B according to the second embodiment.

The obtaining unit 20A obtains the first communication data 40, the first configuration information 42, and the second configuration information 44 (Step S200).

Based on the first configuration information 42 and the second configuration information 44 obtained at Step S200, the generating unit 20C generates the communication prototype information 47 in which the first identification information included in the first communication data 40 is substituted with the corresponding function identification information (Step S202).

The substituting unit 21D substitutes the function identification information included in the communication prototype information 47, which is generated at Step S202, with the second identification information that corresponds to the function identification information and that is included in the second configuration information 44 obtained at Step S200, and generates the communication prediction data 48.

The learning unit 22 performs learning of the learning model 50 based on the communication prediction data 48 generated at Step S204 (Step S206). It marks the end of the present routine.

As explained above, in the information processing device 10B according to the second embodiment, the communication generating unit 21B includes the generating unit 21C and the substituting unit 21D. The generating unit 21C generates, based on the first configuration information 42 and the second configuration information 44, the communication prototype information 47 by substituting the first identification information included in the first communication data 40 with the corresponding function identification information. The substituting unit 21D generates the communication prediction data 48 by substituting the function identification information included in the communication prototype information 47 with the second identification information that corresponds to the function identification information and that is included in the second configuration information 44.

Hence, in an identical manner to the first embodiment described above, the information processing device 10B according to the second embodiment enables holding down a decline in the learning accuracy and shortening the learning time.

Meanwhile, in the embodiments described above, the explanation is given for the example in which the first identification information and the second identification information represents IP addresses. However, as long as the first identification information and the second identification information enables unique identification of the devices 34, it need not be limited to IP addresses. Thus, as the first identification information and the second identification information, it is possible to use a combination of a plurality of types of identification information enabling identification of the devices 34. More particularly, for example, information formed as a result of combining the IP addresses and the port numbers can be used as the first identification information and the second identification information.

Given below is the explanation of an exemplary hardware configuration of the information processing devices 10 and 10B according to the embodiments described above.

FIG. 13 is an exemplary hardware configuration diagram of the information processing devices 10 and 10B according to the embodiments described above.

The information processing devices 10 and 10B according to the embodiments described above have the hardware configuration of a commonly-used computer in which a central processing unit (CPU) 81, a read only memory (ROM) 82, a random access memory (RAM) 83, and a communication interface (I/F) 84 are connected to each other by a bus 85.

The CPU 81 is an arithmetic device that controls the information processing devices 10 and 10B according to the embodiments described above. The ROM 82 is used to store a computer program written for enabling the CPU 81 to implement various operations. The RAM 83 is used to store the data required in the various operations performed by the CPU 81. The communication I/F 84 is an interface for establishing connection with the user interface (UI) unit 14 and the communication unit 16, and enables transmission and reception of data.

In the information processing devices 10 and 10B according to the embodiments described above, the CPU 81 reads a computer program from the ROM 82 into the RAM 83 and executes it, so that functions explained earlier are implemented in the computer.

Meanwhile, the computer program executed in the information processing devices 10 and 10B according to the embodiments for the purpose of implementing the various operations explained earlier can be stored in a hard disk drive (HDD). Alternatively, the computer program executed in the information processing devices 10 and 10B according to the embodiments for the purpose of implementing the various operations explained earlier can be stored in advance in the ROM 82.

Still alternatively, the computer program executed in the information processing devices 10 and 10B according to the embodiments for the purpose of implementing the various operations explained earlier can be stored as an installable file or an executable file in a computer-readable memory medium such as a compact disk read only memory (CD-ROM), a compact disk recordable (CD-R), a memory card, or a digital versatile disk (DVD); and can be provided as a computer program product. Still alternatively, the computer program executed in the information processing devices 10 and 10B according to the embodiments for the purpose of implementing the various operations explained earlier can be stored in a downloadable manner in a computer connected to a network such as the Internet. Still alternatively, the computer program executed in the information processing devices 10 and 10B according to the embodiments for the purpose of implementing the various operations explained earlier can be distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
an obtaining unit that obtains first communication data of a first environment, first configuration information, and second configuration information, the first environment including a plurality of first devices, first identification information of each first device of the plurality of first devices included in the first environment being associated with function identification information of a function of the first device in the first configuration information, second identification information of each second device of a plurality of second devices included in a second environment being associated with function identification information of a function of the second device in the second configuration information; and
a communication generating unit that generates communication prediction data of the second environment by substituting first identification information included in the first communication data with second identification information corresponding to function identification information of a function of a first device identified by the first identification information.

2. The device according to claim 1, wherein the communication generating unit includes:
a generating unit that, based on the first configuration information and the second configuration information, generates identification correspondence information in which first identification information and second identification information corresponding to the same function identification information are associated; and
a substituting unit that generates the communication prediction data by substituting the first identification information included in the first communication data with the second identification information corresponding to the first identification information in the identification correspondence information.

3. The device according to claim 1, wherein the communication generating unit includes:
a generating unit that, based on the first configuration information, generates communication prototype information by substituting the first identification information included in the first communication data with the function identification information corresponding to the first identification information; and
a substituting unit that generates the communication prediction data by substituting the function identification information included in the communication prototype information with second identification information included in the second configuration information and corresponding to the function identification information.

4. The device according to claim 1, wherein, when the first communication data contains first identification information that does not get substituted with second identification information, the communication generating unit deletes the communication prediction data generated from the first communication data.

5. A computer program product comprising a computer-readable medium including programmed instructions, the instructions causing a computer to execute:
obtaining first communication data of a first environment, first configuration information, and second configuration information, the first environment including a plurality of first devices, first identification information of each first device of the plurality of first devices included in the first environment being associated with function identification information of a function of the first device in the first configuration information, second identification information of each second device of a plurality of second devices included in a second environment being associated with function identification information of a function of the second device in the second configuration information; and
generating communication prediction data of the second environment by substituting first identification information included in the first communication data with second identification information corresponding to function identification information of a function of a first device identified by the first identification information.

6. An information processing system comprising:
an obtaining unit that obtains first communication data of a first environment, first configuration information, and second configuration information, the first environment including a plurality of first devices, first identification information of each first device of the plurality of first devices included in the first environment being associated with function identification information of a function of the first device in the first configuration information, second identification information of each of a plurality of second devices included in a second environment being associated with function identification information of a function of the second device in the second configuration information;
a communication generating unit that generates communication prediction data of the second environment by substituting first identification information included in the first communication data with second identification information corresponding to function identification information of a function of a first device identified by the first identification information; and
a learning unit that, based on the communication prediction data, performs learning of a learning model which outputs whether or not communication data of the second environment is normal.
